(19) United States
(12) Patent Application Publication
(10) Pub. No.: US 2020/0115565 A1
(43) Pub. Date: Apr. 16, 2020

(54) POLYMER COATING OF METAL ALLOY SUBSTRATES

(71) Applicant: Hewlett-Packard Development Company, L.P., Spring, TX (US)

(72) Inventors: Chi-Hao Chang, Taipei City (TW); Kuo-Chih Huang, Taipei City (TW); Kuan-Ting Wu, Taipei City (TW)

(73) Assignee: Hewlett-Packard Development Company, L.P., Spring, TX (US)

(21) Appl. No.: 16/499,646

(22) PCT Filed: Apr. 11, 2017
(86) PCT No.: PCT/US2017/026964

§ 371 Date: Sep. 30, 2019

(51) Int. Cl. C09D 5/44; C25D 13/22; C25D 13/04; C09D 5/00; C09D 175/04

(52) U.S. Cl. CPC C09D 5/4484; C25D 13/22; C25D 13/04; C09D 175/04; C09D 5/443; C09D 5/002; C09D 5/4411

(57) ABSTRACT

The present subject matter relates to polymer coating of a metal alloy substrate. The metal alloy substrate has an electrolytically deposited nano-ion polymer layer thereon. The nano-ion polymer layer is of a polyacrylic material or an epoxy resin.

### BACKGROUND

Metal alloy substrates are used for fabrication of various components of devices. The components may include body parts of devices, such as mobile phones, tablets, laptops, stylus, keyboards, and the like. The metal alloy substrate may be made of magnesium, aluminum, copper, titanium, or a combination of similar light weight metals.

### BRIEF DESCRIPTION OF DRAWINGS

The following detailed description references the drawings, wherein:

FIG. 1 illustrates a sectional view of a polymer coated metal alloy substrate, according to an example of the present subject matter;

FIG. 2 illustrates a setup for electrolytically coating a nano-ion polymer layer on a metal alloy substrate in the presence of ultrasonic vibrations, according to an example of the present subject matter,

FIG. 3 illustrates a sectional view of a polymer coated metal alloy substrate having a polyurethane paint layer, according to an example of the present subject matter;

FIG. 4 illustrates a sectional view of a polymer coated metal alloy substrate having an ultraviolet paint layer, according to an example of the present subject matter;

FIG. 5 illustrates a sectional view of a polymer coated metal alloy substrate having a polyurethane paint layer and an ultraviolet paint layer, according to an example of the present subject matter;

FIG. 6 illustrates a method of coating a polymer layer on a metal alloy substrate, according to an example of the present subject matter; and

FIG. 7 illustrates a method of fabricating a polymer coated metal alloy substrate, according to an example of the present subject matter.

### DETAILED DESCRIPTION

Metal alloy substrates made of magnesium, aluminum, copper, titanium, or a combination thereof, are strong and are light in weight. Such metal alloy substrates are generally used for manufacturing body parts, housings, enclosures of portable or handheld devices, such as mobile phones, tablets, laptops, styluses. keyboards, and the like.

Bare metal alloy substrates are prone to corrosion which may affect the durability of components made of metal alloy substrates. To enhance the durability of the components made of metal alloy substrates, the metal alloy substrates are generally made corrosion free by coating multiple layers of polymer on the metal alloy substrates. Each layer of polymer may be spray coated. After coating one layer, the metal alloy substrate may be packed and taken to a processing machine for surface processing, for example, puttying and polishing, of the metal alloy substrate. After the surface processing, the metal alloy substrate may be re-packed and taken back to a coating machine for coating another layer of polymer. Further, before coating the layer of polymer, the metal alloy substrate may have to be cleaned to avoid contamination by suspended particle deposition or due to contacts during handling, thereby avoiding non-uniformity in coating of the layer of polymer. The procedure of coating multiple layers of polymers to make the metal alloy substrate corrosion free is tedious and laborious which significantly increases the production time and the cost of manufacturing corrosion free metal alloy substrates and components made of metal alloy substrates.

The present subject matter describes approaches for polymer coating of metal alloy substrates. The approaches of the present subject matter involve electrolytically coating a nano-ion polymer (NIP) layer on a metal alloy substrate in the presence of ultrasonic vibrations. The NIP layer may be of a polyacrylic material or an epoxy resin. The approaches for polymer coating of metal alloy substrates, according to examples of the present subject matter, are easy and fast and involve less amount of handling of the metal alloy substrates during the polymer coating procedure. Thus, with the approaches of the present subject matter the production time and the cost for manufacturing corrosion free metal alloy substrates and components of metal alloy substrates are reduced.

In an example implementation of the present subject matter, a metal alloy substrate is immersed in an electrolytic solution. The electrolytic solution includes an anionic polymer of, for example, a polyacrylic material or an epoxy resin. For coating a polymer layer on the metal alloy substrate, a predetermined voltage is provided to the metal alloy substrate, which electrolyzes the electrolytic solution. The predetermined voltage may be in a range of 10 V to 120 V. As a result of electrolysis, nano-particles of the anionic polymer in the electrolytic solution are released and are deposited on the metal alloy substrate to form a NIP layer of the anionic polymer on the metal alloy substrate. The NIP layer is a dense and uniform protection layer on the metal alloy substrate which makes the metal alloy substrate corrosion free.

The methodology of coating a polymer layer of a metal alloy substrate, according to the present subject matter, is simple and easy. With the methodology of the present subject matter, the metal alloy substrate does not have to be moved back and forth between a coating machine and a processing machine for obtaining a corrosion free metal alloy substrate. As a result, the chances of contamination and the amount of handling of the metal alloy substrate during the polymer coating procedure are reduced substantially. Reduction in the amount of handling of the metal alloy substrate reduces the production time and cost.

Further, in an example implementation of the present subject matter, the electrolytic solution and the metal alloy substrate immersed in the electrolytic solution may be subjected to ultrasonic vibrations during the electrolysis. The ultrasonic vibrations facilitate strong binding of nano-ion polymers with the metal alloy substrate. Further, the nano-ion polymers may fill up the micro-pores that may be present on the surface of the metal alloy substrate. Thus, the polymer layer on the metal alloy substrate may have better surface uniformity in comparison to a spray coated polymer layer on a metal alloy substrate.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

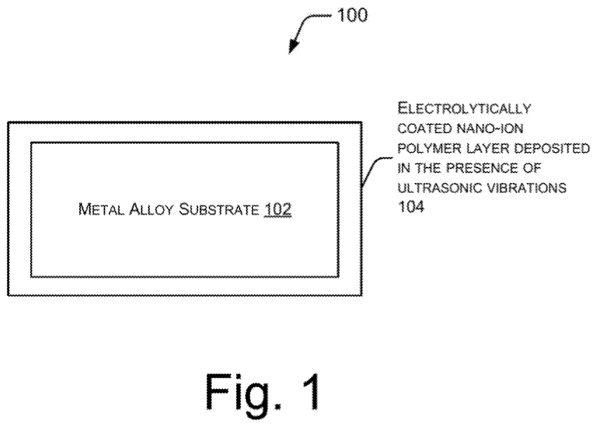

FIG. 1 illustrates a sectional view of a polymer coated metal alloy substrate 100, according to an example of the present subject matter. The polymer coated metal alloy substrate 100 includes a metal alloy substrate 102. The metal alloy substrate 102 may be made of one of magnesium, aluminum, zinc, titanium, lithium, niobium, steel, copper, and a combination thereof.

The polymer coated metal alloy substrate 100, as shown in FIG. 1, also includes an NIP layer 104 on the metal alloy substrate 102. The NIP layer 104 is of an anionic polymer, such as a polyacrylic material or an epoxy resin. The NIP layer 104 may be all around the metal alloy substrate 102, as depicted in the sectional view in FIG. 1. The NIP layer 104 may have a thickness in a range of 5 micrometers to 25 micrometers.

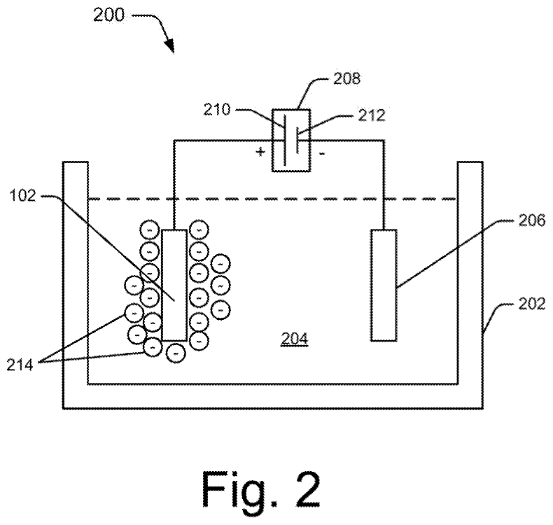

In an example implementation, the NIP layer 104 is coated or deposited on the metal alloy substrate 102 through electrolysis of an electrolytic solution having the anionic polymer. The metal alloy substrate 102 is immersed in the electrolytic solution and a predetermined voltage, in a range of 10 V to 120 V, is provided to the metal alloy substrate for coating the NIP layer 104. In an example implementation, the NIP layer 104 may be coated in the presence of ultrasonic vibrations. For this, the electrolytic solution and the metal alloy substrate 102 immersed in the electrolytic solution are subjected to ultrasonic vibrations while the predetermined voltage is being provided to the metal alloy substrate. The ultrasonic vibrations may be provided at a frequency in a range of about 20 Hz to about 20,000 Hz. An example procedure to coat the NIP layer 104 on the metal alloy substrate 102 is described in detail with reference to FIG. 2.

In an example implementation, components, such as body parts, housings, and enclosures of portable or handheld devices may be made of polymer coated metal alloy substrate 100. For this, the metal alloy substrate 102 may be forged, die-casted, computer-numeric control (CNC) machined, or molded, in the shape of the component, prior to coating the NIP layer 104.

Further, in an example implementation, the metal alloy substrate 102, prior to coating the NIP layer 104, may be cleaned, washed, polished, degreased, and/or activated. The metal alloy substrate may be chemically cleaned using an alkaline agent, for example, sodium hydroxide. The metal alloy substrate may be washed in a buffer solution. The cleaning and washing of the metal alloy substrate may help in removing foreign particles, if any, present on the surface of the metal alloy substrate. Further, the metal alloy substrate may be chemically polished using abrasives to remove irregularities that may be present on the surface of the metal alloy substrate. The metal alloy substrate may also be degreased through ultrasonic degreasing to remove impurities, such as fat, grease, or oil from the surface of the metal alloy substrate. Further, the metal alloy substrate may also be activated through acid treatment for removing the natural oxide layer, if any, present on the surface of the metal alloy substrate.

FIG. 2 illustrates a setup 200 for electrolytically coating the NIP layer 104 on the metal alloy substrate 102 in the presence of ultrasonic vibrations, according to an example of the present subject matter. The setup 200, as shown, has an ultrasonic cleaner 202 that can operate at ultrasonic frequencies in a range of 20 Hz to 20,000 Hz. The ultrasonic cleaner 202 has a container that can hold liquids in which a substrate may be immersed for providing ultrasonic vibrations.

For the purpose of coating the NIP layer 104 on the metal alloy substrate 102, an electrolytic solution 204 comprising an anionic polymer is poured into the container of the ultrasonic cleaner 202. The anionic polymer may be one of a polyacrylic material or an epoxy resin. The anionic polymer may have a concentration in a range of about 8% by weight to about 12% by weight. The electrolytic solution 204 with the anionic polymer may have pH value in a range of 8 to 9. Further, the electrolytic solution 204 may be at a temperature in range of 25° Celsius (C) to 40° C.

In an example implementation, the electrolytic solution 204 may also include nano-size particles of ceramics, titanium dioxide, silica, day, pearl, barium sulfate, talc, carbon black, mica, calcium carbonate, metallic powders, carbon nano-tubes, graphene, graphite, dye, fluorescent pigments, color pigments, organic powders, and/or inorganic powders. The nano-size particles may have a concentration in a range of 0.1% by weight to 3.5% by weight. Such nano-size particles may be added to the electrolytic solution 204 to provide different colors and surface finish to the NIP layer on the metal alloy substrate.

After pouring the electrolytic solution 204 in the container of the ultrasonic cleaner 202, the metal alloy substrate 102 is immersed as an anode terminal in the electrolytic solution 204. Also, an element, such as a graphite block 206, is immersed as a cathode terminal in the electrolytic solution 204. For this, the metal alloy substrate 102 and the graphite block 206 are electrically connected to a positive terminal 210 and a negative terminal 212 of a voltage source 208, respectively, and immersed in the electrolytic solution 204. The voltage source 208 may be a constant voltage source or a variable voltage source that can provide a predetermined voltage in a range of 10 V to 120 V.

In an example implementation, the metal alloy substrate 102 may be formed in a shape of a component that is to be made of the polymer coated metal alloy substrate. Also, the metal alloy substrate may be cleaned, washed, polished, degreased, and/or activated, in a manner as described above, before coating an NIP layer on the metal alloy substrate 102.

After immersing the metal alloy substrate 102 and the graphite block 206 in the electrolytic solution, the voltage source 208 may be switched ON to provide a predetermined voltage across the metal alloy substrate 102 and the graphite block 206. The predetermined voltage electrolyzes the electrolytic solution 204, which causes negatively charged nano-particles 214 of anionic polymer, present in the electrolytic solution 204, to move towards the anode terminal, i.e., the metal alloy substrate 102. As a result, the negatively charged nano-particles 214 of anionic polymer form a NIP layer on the metal alloy substrate 102.

Further, in an example implementation, the ultrasonic cleaner 202 may be switched ON, while the voltage source 208 is switched ON, to provide ultrasonic vibrations to the electrolytic solution 204 and the metal alloy substrate 102 during the electrolysis of the electrolytic solution 204. The ultrasonic cleaner 202 may be operated at a predetermined ultrasonic frequency in a range of 20 Hz to 20.000 Hz.

In an example implementation, the predetermined voltage for electrolysis of electrolytic solution 204 may be provided for a time duration in a range of 20 seconds to 3 minutes. After this time duration, the voltage source 208 and the ultrasonic cleaner 202 are switched OFF, and the metal alloy substrate 102, coated with the NIP layer, is removed from the electrolytic solution 204. After this, the metal alloy substrate, coated with the NIP layer, is heated at a temperature in a range of 120° C. to 190C for a time duration in a range of 20 minutes to 40 minutes. This heating of the metal alloy substrate cures the NIP layer. In an example implementation, the NIP layer coated on the metal alloy substrate 102 may have a thickness in a range of 5 micrometers to 25 micrometers.

It may be noted that the predetermined voltage from the voltage source 208, the predetermined ultrasonic frequency from the ultrasonic cleaner 202, and the time duration for which the voltage source 208 is switched ON, may vary depending on the type of metal alloy substrate 102 and the type of anionic polymer in the electrolytic solution 204.

In an example implementation, one or more than one paint layer may be coated on the polymer coated metal alloy substrate 100. The paint layer may be a functional layer, such as a metallic coating, UV coating, anti-finger print coating, soft touch coating, anti-bacterial coating, anti-smudge coating, silky coating, and the like.

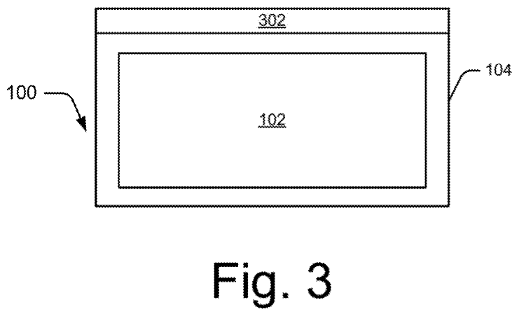

FIG. 3 illustrates a sectional view of the polymer coated metal alloy substrate 100 having a polyurethane paint layer 302, according to an example of the present subject matter. The polyurethane paint layer 302 may be of a material including nano-size polyurethane particles dispersed in polyurethane, polyacrylic and polyester dispersions. The polyurethane paint layer 302 may have a thickness in a range of 10 micrometers to 25 micrometers.

In an example implementation, the polyurethane paint layer 302 may be spray coated on the NIP layer of the polymer coated metal alloy substrate 100. After spray coating the polyurethane paint layer 302, the polymer coated metal alloy substrate 100 is heated at a temperature in a range of 60° C. to 150° C. for a time duration in a range of 15 minutes to 40 minutes. This heating of the metal alloy substrate cures the polyurethane paint layer 302.

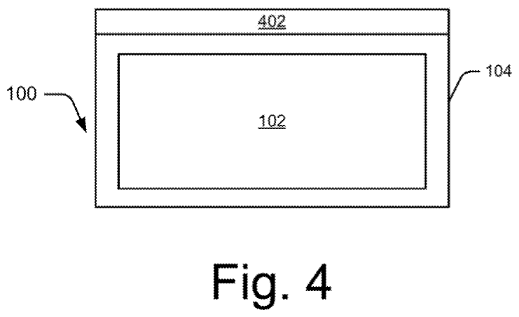

FIG. 4 illustrates a sectional view of a polymer coated metal alloy substrate 100 having an ultraviolet paint layer 402, according to an example of the present subject matter. The ultraviolet paint layer 402 may be a water-based ultraviolet paint including polyurethane acrylate resin, fluorinated polyurethane-acrylic acid resin, methacrylic acid-2-hydroxyethyl ester resin, isocyanate and aliphatic polyurethane acrylic resin. The ultraviolet paint layer 402 may have a thickness in a range of 10 micrometers to 25 micrometers.

In an example implementation, the ultraviolet paint layer 402 may be spray coated on the NIP layer of the polymer coated metal alloy substrate 100. After spray coating the ultraviolet paint layer 402, the polymer coated metal alloy substrate 100 is heated at a temperature in a range of 50° C. to 60° C. for a time duration in a range of 10 minutes to 15 minutes. This heating of the metal alloy substrate cures the ultraviolet paint layer 402. After heating, the ultraviolet paint layer 402 is exposed to ultraviolet radiations of an energy dose of 700 mJ/cm² to 1,200 mJ/cm² for a time duration in a range of 15 seconds to 60 seconds.

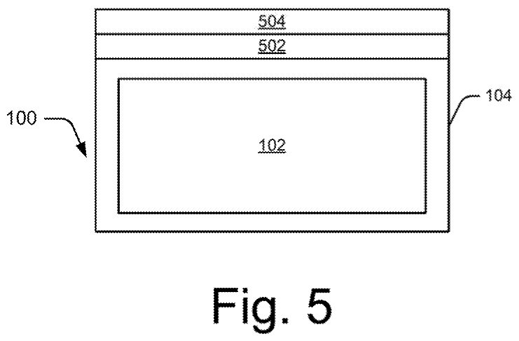

FIG. 5 illustrates a sectional view of a polymer coated metal alloy substrate 100 having a polyurethane paint layer 502 and an ultraviolet paint layer 504, according to an example of the present subject matter. As shown in FIG. 5, the polyurethane paint layer 502 is on the NIP layer 104, and the ultraviolet paint layer 504 is on the polyurethane paint layer 502. The polyurethane paint layer 502 and the ultraviolet paint layer 504 may be coated in a manner similar to as described above with reference to FIGS. 3 and 4.

It may be noted that in FIGS. 3 to 5, the polyurethane paint layer and the ultraviolet paint layer are shown on one side/surface of the polymer coated metal alloy substrate 100. In an example implementation, the polyurethane paint layer and the ultraviolet paint layer may be coated on multiple surfaces of the polymer coated metal alloy substrate 100. A surface of the polymer coated metal alloy substrate 100 which may be exposed to the environment, when the substrate 100 is used as a component of a device, is coated with the polyurethane paint layer and/or the ultraviolet paint layer.

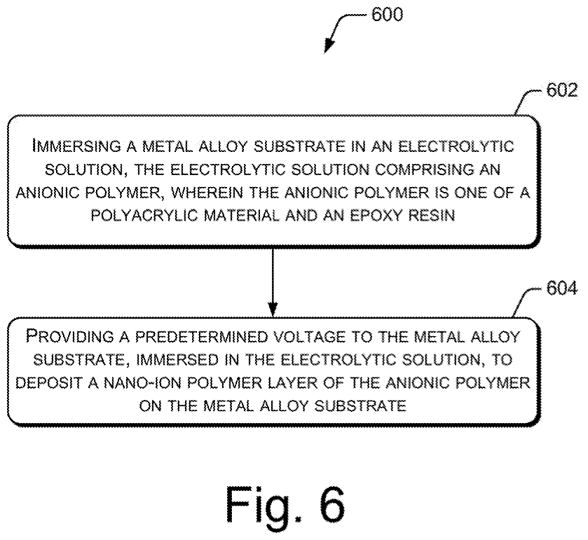

FIG. 6 illustrates a method 600 of coating a polymer layer on a metal alloy substrate, according to an example of the present subject matter. The polymer layer may be the NIP layer 104 coated on the metal alloy substrate 102 to obtain the polymer coated metal alloy substrate 100, as described above. The metal alloy substrate may be made of one of magnesium, aluminum, zinc, titanium, lithium, niobium, steel, copper, and/or a combination thereof. The metal alloy substrate may be formed in a shape of a component, such as a body part of a device. As described earlier, the metal alloy substrate may be cleaned, washed, polished, degreased, and/or activated, prior to coating a NIP layer on the metal alloy substrate.

At block 602 of the method 600, the metal alloy substrate is immersed in an electrolytic solution including an anionic polymer. The anionic polymer may be one of a polyacrylic material and an epoxy resin. The concentration of the anionic polymer in the electrolytic solution, the pH value of the electrolytic solution, and the temperature of the electrolytic solution, may have values as described earlier. The metal alloy substrate may be immersed as an anode terminal in the electrolytic solution. In addition, a graphite block may be immersed as a cathode terminal in the electrolytic solution.

At block 604, a predetermined voltage is provided to the metal alloy substrate, immersed in the electrolytic solution, to deposit a NIP layer of the anionic polymer on the metal alloy substrate. The predetermined voltage may be in a range of 10 V to 120 V. In an example implementation, the NIP layer coated on the metal alloy substrate 102 may have a thickness in a range of 5 micrometers to 25 micrometers.

In an example implementation, the electrolytic solution may be held in a container of an ultrasonic cleaner, and the electrolytic solution and the metal alloy substrate immersed in the electrolytic solution are treated at a predetermined ultrasonic frequency while the predetermined voltage is being provided to the metal alloy substrate. The predetermined ultrasonic frequency may be in a range of 10 Hz to 10000 Hz.

The predetermined voltage may be provided to the metal alloy substrate for a time duration in a range of 20 seconds to 3 minutes, after which the metal alloy substrate, coated with the NIP layer, is removed from the electrolytic solution. The metal alloy substrate, coated with the NIP layer, is then heated at a temperature in a range of 120° C. to 190° C. for a time duration in a range of 20 minutes to 40 minutes.

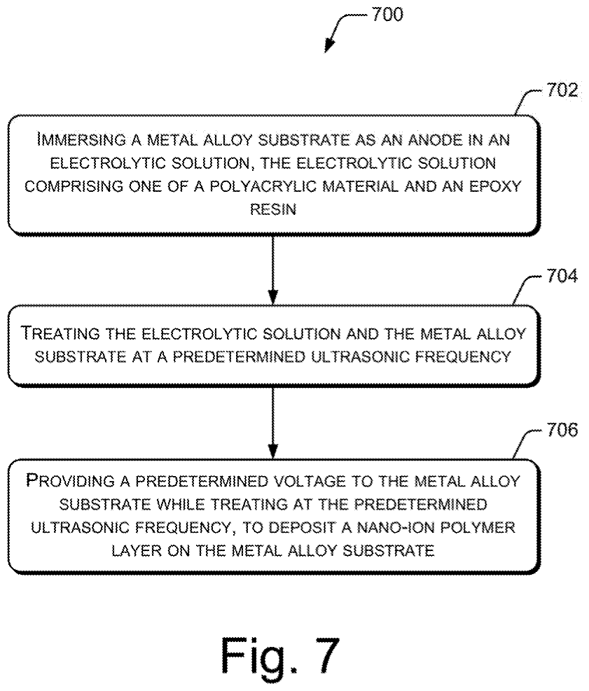

FIG. 7 illustrates a method 700 of fabricating a polymer coated metal alloy substrate, according to an example of the present subject matter. The method 700 may be used to fabricate the polymer coated metal alloy substrate 100, as described above. The metal alloy substrate may be made of one of magnesium, aluminum, zinc, titanium, lithium, niobium, steel, copper, and a combination thereof. The metal alloy substrate may be formed in a shape of a component, such as a body part of a device. As described earlier, the metal alloy substrate may be cleaned, washed, polished, degreased, and/or activated, prior to coating an NIP layer on the metal alloy substrate.

At block 702 of the method 700, the metal alloy substrate is immersed as an anode in an electrolytic solution. The electrolytic solution includes one of a polyacrylic material and an epoxy resin of concentration in a range of 8% to 12% by weight. The electrolytic solution may have a pH value of 8 to 9. Further, a graphite block may be immersed as a cathode in the electrolytic solution.

At block 704, the electrolytic solution and the metal alloy substrate are treated at a predetermined ultrasonic frequency. The predetermined ultrasonic frequency may be in a range as described above. At block 706, a predetermined voltage is provided to the metal alloy substrate while treating at the predetermined ultrasonic frequency, to deposit a NIP layer on the metal alloy substrate. The predetermined voltage may be in a range as described earlier.

The predetermined voltage may provide for a time duration in a range of 20 seconds to 3 minutes. After this, the metal alloy substrate, coated with the NIP layer, is removed from the electrolytic solution, and heated at a temperature in a range of 120° C. to 190° C. for a time duration in a range of 20 minutes to 40 minutes.

In an example implementation, after heating the metal alloy substrate, coated with the NIP layer, a polyurethane paint layer may be spray coated on the NIP layer. The metal alloy substrate, coated with the NIP layer and with the polyurethane paint layer, may then be heated at a temperature in a range of 60° C. to 150° C. for a time duration in a range of 15 minutes to 40 minutes.

In an example implementation, after heating the metal alloy substrate, coated with the NIP layer, an ultraviolet paint layer may be spray coated on the NIP layer. The metal alloy substrate, coated with the NIP layer and with the ultraviolet paint layer, may then be heated at a temperature in a range of 50° C. to 60° C. for a time duration in a range of 10 minutes to 15 minutes. After this heating, the ultraviolet paint layer may be exposed to ultraviolet radiations of an energy dose of 700 mJ/cm² to 1,200 mJ/cm² for a time duration in a range of 15 seconds to 60 seconds.

In an example implementation, after coating a polyurethane paint layer on the NIP layer, an ultraviolet paint layer may be coated on the polyurethane paint layer.

Although examples for the present disclosure have been described in language specific to structural features and/or methods, it is to be understood that the appended claims are not limited to the specific features or methods described herein. Rather, the specific features and methods are disclosed and explained as examples of the present disclosure.

We claim:

1. A method of coating a polymer layer on a metal alloy substrate, the method comprising:
immersing the metal alloy substrate in an electrolytic solution, the electrolytic solution comprising an anionic polymer, wherein the anionic polymer is one of a polyacrylic material and an epoxy resin; and
providing a predetermined voltage to the metal alloy substrate, immersed in the electrolytic solution, to deposit a nano-ion polymer (NIP) layer of the anionic polymer on the metal alloy substrate.

2. The method as claimed in claim 1, wherein the anionic polymer in the electrolytic solution has a concentration in a range of about 8% by weight to about 12% by weight.

3. The method as claimed in claim 1, wherein the metal alloy substrate is immersed in the electrolytic solution as an anode terminal.

4. The method as claimed in claim 3, comprising immersing a graphite block as a cathode terminal in the electrolytic solution.

5. The method as claimed in claim 1, wherein the electrolytic solution is in a container of an ultrasonic cleaner, wherein the method comprises:
treating the electrolytic solution and the metal alloy substrate at a frequency in a range of about 20 Hz to about 20,000 Hz while the predetermined voltage is being provided to the metal alloy substrate.

6. The method as claimed in claim 5, comprising:
removing the metal alloy substrate, coated with the NIP layer, from the electrolytic solution; and
heating the metal alloy substrate, coated with the NIP layer, at a temperature in a range of 120° C. to 190° C. for a time duration in a range of 20 minutes to 40 minutes.

7. The method as claimed in claim 1, wherein the predetermined voltage is in a range of 10 V to 120 V.

8. The method as claimed in claim 1, wherein the metal alloy substrate is made of one of magnesium, aluminum, zinc, titanium, lithium, niobium, steel, copper, and a combination thereof.

9. A method of fabricating a polymer coated metal alloy substrate, the method comprising:
immersing a metal alloy substrate as an anode in an electrolytic solution, the electrolytic solution comprising one of a polyacrylic material and an epoxy resin;
treating the electrolytic solution and the metal alloy substrate at a predetermined ultrasonic frequency; and
providing a predetermined voltage to the metal alloy substrate while treating at the predetermined ultrasonic frequency, to deposit a nano-ion polymer (NIP) layer on the metal alloy substrate.

10. The method as claimed in claim 9, comprising:
removing the metal alloy substrate, coated with the NIP layer, from the electrolytic solution; and
heating the metal alloy substrate, coated with the NIP layer, at a temperature in a range of 120′C to 190° C. for a time duration in a range of 20 minutes to 40 minutes.

11. The method as claimed in claim 10, comprising:
spray coating a polyurethane paint layer on the NIP layer; and
heating the metal alloy substrate, coated with the NIP layer and with the polyurethane paint layer, at a temperature in a range of 60° C. to 150° C. for a time duration in a range of 15 minutes to 40 minutes.

12. The method as claimed in claim 10, comprising:
spray coating an ultraviolet paint layer on the NIP layer;
heating the metal alloy substrate, coated with the NIP layer and with the ultraviolet paint layer, at a temperature in a range of 50° C. to 60° C. for a time duration in a range of 10 minutes to 15 minutes; and
exposing the ultraviolet paint layer to ultraviolet radiations of an energy dose of 700 mJ/cm² to 1,200 mJ/cm² for a time duration in a range of 15 seconds to 60 seconds.

13. A polymer coated metal alloy substrate comprising:
a metal alloy substrate; and
an electrolytically coated nano-ion polymer (NIP) layer of an anionic polymer, deposited in the presence of ultrasonic vibrations, on the metal alloy substrate, the anionic polymer being one of a polyacrylic material and an epoxy resin.

14. The polymer coated metal alloy substrate as claimed in claim 13, comprising a polyurethane paint layer on the NIP layer.

15. The polymer coated metal alloy substrate as claimed in claim 14, comprising an ultraviolet paint layer on the polyurethane paint layer.
